(19) United States
(12) Patent Application Publication
(10) Pub. No.: US 2002/0035421 A1
(43) Pub. Date: Mar. 21, 2002

(54) System and method for recording and processing driver data including hours of service

(76) Inventor: Colin D. Warkentin, St. Catherine's (CA)

Correspondence Address: Isis E. Caulder, Bereskin & Parr, 40 King Street West, Box 401, Toronto, ON, M5H 3Y2, CA

(21) Appl. No.: 09/951,449

(22) Filed: Sep. 14, 2001

Related U.S. Application Data
(60) Provisional application No. 60/232,605, filed on Sep. 14, 2000.

(51) Int. Cl. G06F 19/00; G01C 21/26

(52) U.S. Cl. 701/29; 701/200; 709/200

(57) ABSTRACT

The present invention provides a system for recording and processing driving data for a driver of a motor carrier, comprising: (a) a portable computing device associated with the driver, the portable computing device being adapted to record driving data for the driver; (b) a wireless communications system coupled to the portable computing device for wirelessly connecting the device to a wide-area communications network; and (c) a software program accessible on the wide-area communications network for processing driving data received from the portable computing device through the wireless communications system. Preferably, the driving data includes hours of service data for the driver. The portable computing device includes a memory for storing rules for hours of service in a given time period and the device further includes a warning system responsive to the hours of service data for the driver for warning the driver when a rest period is required.

This application claims priority from U.S. Provisional Patent Application No. 60/1232,605, filed Sept. 14, 2000.

### FIELD OF THE INVENTION

This invention relates to the field of recording and processing driving data, including hours of service data, for drivers in the transportation industry.

### BACKGROUND OF THE INVENTION

The transportation industry, and in particular the motor carrier segment, is inundated with paperwork including driver time sheets, bills of lading, and invoices. As well, there are regulatory requirements such as hours of service compliance, and fuel & miles tax reporting with associated paperwork. A majority of the paperwork is generated by the driver. Existing solutions developed to cope with the paper load typically consist of entering data into an office computer system once the paperwork has been collected and submitted by the driver.

Currently, drivers of motor carriers are required to complete a paper log book that logs the hours and locations of time spend working, driving, off duty, and in a sleeper berth. Hours of service regulations strictly regulate the number of hours a driver may drive within a given time period to ensure that he/she has had sufficient rest periods between driving engagements. One objective of these mandatory rest periods is to reduce the number of traffic accidents and fatalities related to tired drivers failing asleep at the wheel.

There are numerous drawbacks in the paper-based systems currently in use for recording hours of service data. These include, for example, the difficulty in calculating available hours left to drive in a given time period. Simple errors in completing the log book can lead to severe fines and penalties. In addition, with paper-based systems, there may be problems associated with falsification of log books by drivers and the associated difficulty in auditing the log books to ensure compliance with regulations. Often, the problems associated with paper-based systems are exacerbated by the inability to transfer the logs from the driver to the main office in a timely and efficient manner. Given the schedules that manly truck drivers keep, it is not uncommon for the drivers to submit their paperwork only once a month. These cyclical waves of paperwork cause a ripple effect and result in delays associated with processing.

As an alternative to the existing paper-based systems, some truck operators are presently using electronic recording devices installed on-board trucks. These on-board systems, while technically sophisticated, can be prohibitively expensive and difficult to use. Typically, these on-board systems are linked by satellite and the equipment necessary to establish a satellite link may be expensive. The main difficulty associated with these on-board devices, however, is that they are associated with the truck and not the driver. As it is not uncommon for drivers to change vehicles during the day, or overnight, such on-board devices may be of limited value in tracking hours of service data for an individual driver over any length of time.

Due to a number of factors, such as the proliferation of logistic providers squeezing freight rates, rising fuel costs, and ongoing legislative and regulatory issues, the profit margins enjoyed by many carriers tire relatively small. Sophisticated and costly on-board systems may not be a feasible option for many of these carriers. What is needed is a system for recording and processing hours of service data and other driving data in an efficient and cost effective manner and which provides useful feedback information available to the driver.

### SUMMARY OF THE INVENTION

In an aspect of the present invention, there is provided a system for tracking driving data for a driver of a motor carrier, comprising: (a) a portable computing device associated with said driver, said portable computing device being adapted to record driving data for said driver; (b) a wireless communications system coupled to said portable computing device for wirelessly connecting said device to a wide-area communications network; and (c) a software program accessible on said wide-area communications network for processing driving data received from said portable computing device through said wireless communications system.

Preferably, the driving data includes hours of service data for said driver.

Preferably, the driving data includes fuel & miles tax data for said driver.

More preferably, the portable computing device includes a memory for storing rules for hours of service in a given time period, and said device further includes a warning system responsive to the hours of service data for said driver for warning said driver when a rest period is required.

In one embodiment, the wireless communications system is adapted to communicate with a cellular telecommunications network.

In another embodiment, the wide-area communications network comprises the internet.

In another aspect, there is provided a method for recording and processing driving data for a driver of a motor carrier, comprising the steps of: (a) providing a portable computing device associated with said driver: (b) recording driving data for said driver on said portable computing device; (c) communicating the driving data to a wide-area communications network using a wireless communications system coupled to said portable computing device; and (d) operating a software program accessible on said wide area communications network for processing driving data received from said portable computing device through said wireless communications system.

Preferably, the method includes recording hours of service data for said driver.

More preferably, the method includes storing rules for hours of service in a given time period and warning said driver when a rest period is required based on the hours of service recorded for said driver.

In one embodiment the wireless communications system communicates with a cellular telecommunications network.

In another embodiment, the wide-area communications network comprises the internet.

In yet another aspect, there is provided a portable device for tracking driver data for a driver of a motor carrier, comprising: (a) a memory for storing rules for hours of service and recording hours of service data for said driver; (b) a software program operating on said portable device for processing said hours of service data for said driver and comparing said hours of service data to said rules for hours of service to determine compliance with said rules, and (c) warning system responsive to said hours of service data for warning said driver when compliance with said rules is about to be broached.

### BRIEF DESCRIPTION OF THE DRAWINGS

For a better understanding of the present invention, and to show more clearly how it may be carried into effect, reference will now be made, by way of example, to the accompanying drawings which show a preferred embodiment of the present invention and in which:

FIG. 1 shows a schematic diagram of a system in accordance with an embodiment of the present invention;

FIG. 2 shows a data collection device on accordance with an embodiment of the present invention;

FIG. 3 shows a sample of a display in the data collection device of FIG. 2; and

FIG. 4 shows a flow-chart illustrating use of the data collection device of FIG. 2 by a driver for recording and processing hours of service information.

### DETAILED DESCRIPTION OF THE INVENTION

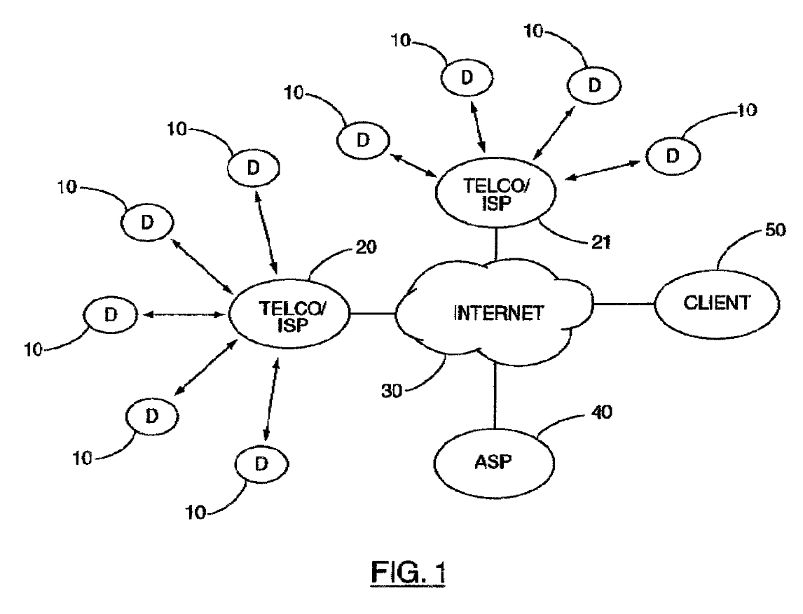

Referring to FIG. 1, a model of the system according to the present invention is shown. To reduce the many inefficiencies of existing paper-based system as described earlier, recognizing that a majority of the paperwork is generated by the driver, the present inventor has realized that a data collection device 10 must reside with the driver and not in the main office or installed on-board a truck. Also, to remove the obstacle of geography, the inventor has realized that the internet 30 can be used as a readily accessible communications infrastructure through which data from a vast geographic area can be collected to a central location at relatively low cost.

The model shown in FIG. 1 consists of the integration of a number of components, First, a portable data collection device 10 is issued to each driver in the field. The data collection devices 10 are preferably equipped with a wireless communications system such as a wireless modem (not shown) which allows each of the devices 10 to be connected to any one of a plurality or private or common carrier telecommunications networks 20, 21. While connection by wireless means is preferred, connection may also be by wireline, satellite, etc. It will be appreciated that if connection is by wireline, data collection will be intermittent and dictated by the availability of a wireline connection.

Still referring to FIG. 1, an Internet service provider (ISP) provides access to the internet 30 through the telecommunications networks 20, 21. As shown, the telecommunications networks 20, 21 may be geographically separated such that the devices 10 may be distributed over a wide geographical area. The telecommunications networks 20, 21 in turn allow access, by dial-in or by dedicated connection, to the internet 30.

Still referring to FIG. 1, appropriate data processing web-applications (including hours of service, fuel & miles tax, time-sheets, and driver e-mail) are hosted on a server operated by an application service provider (ASP) 40. The ASP 40 is likewise connected to the internet 30 and web-applications hosted by the ASP 40 may receive driving data from the devices 10 in the field through the telecommunications networks 20, 21 and the internet 30. A web-application hosted by the ASP 40 may store, process, and generate reports based on the driving data received from the devices 10.

Still referring to FIG. 1, a client 60 is also connected to the internet either directly or through an ISP (not shown) and has access to the web-applications hosted by the ASP 40. When clients 50 such as carriers and owner-operators log onto the web-applications, they can be taken to a data-secure site that allows them access to the applications they are registered to use. The web-applications may generate any necessary reports, which can be viewed on-line, taxed or e-mailed to the client 50. The web-applications may also store the log information for any stipulated period, typically 6 months. The date may also be duplicated on a redundant server to endure security and high-availability.

It is also possible that the client 50 may have direct access to the devices 10 In the field. However, in the preferred system shown in FIG. 1, the client has access to the devices 10 (e.g. driver e-mail) through the web-applications hosted by the ASP 40. In this manner, the client 50 does not need to be concerned about managing the communications with the devices 10 and need only be familiar with accessing one or more web-applications hosted by the ASP 40 through the internet 30.

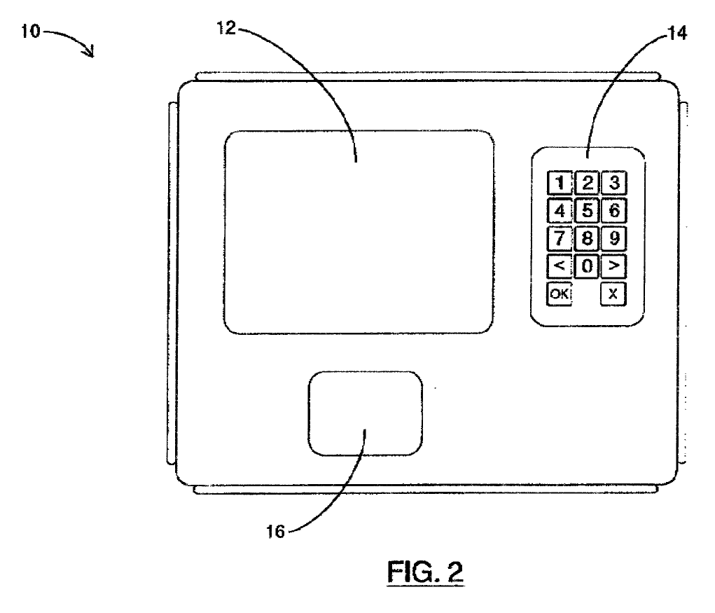

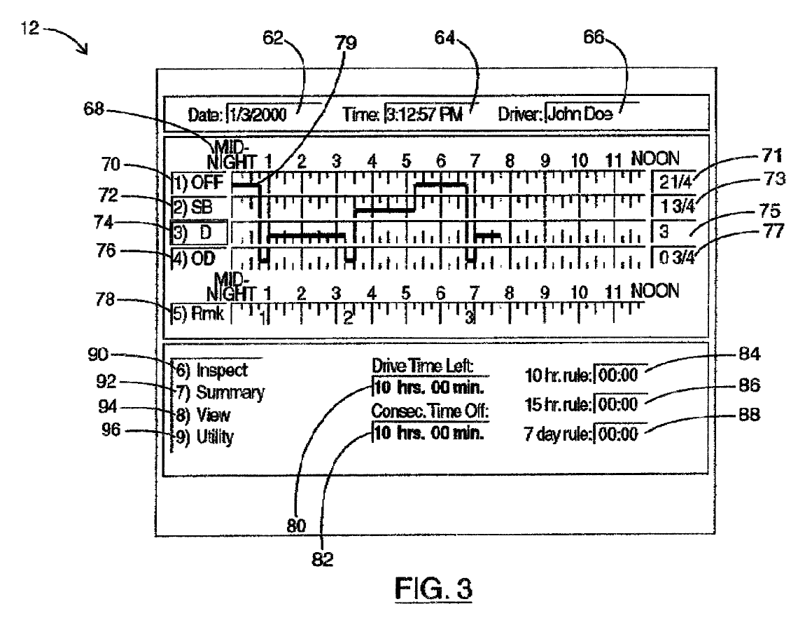

Now referring to FIG. 2, the portable data collection device 10 of FIG. 1 is shown In enlarged detail. As shown, the device 10 contains a large display area 12 to provide detailed driving status information. Preferably, the display area 12 will display an easy to use graphical user interface (an example is shown in FIG. 3). A keypad 14 is provided for driver input and for selecting various menu options displayed in the display area 12. While a numeric keypad 16 is shown, it will be appreciated that the keypad 14 may also be alphanumeric. A writing pad 16 may also be provided to electronically capture a driver's location, remarks, and the driver's signature when necessary. Also preferably provided with the device 10 is a wireless modem (not shown) for connecting to a telecommunications network 20, 21 (FIG. 1) and to the Internet 30. Optionally, a wireline modem (not shown) may be provided for intermittent connection to a telecommunications network 20, 21 by wireline. Furthermore, the device 10 can incorporate a global positioning system (GPS) module (not shown) and a connection interface to the truck (not shown) for determining operational status of tho vehicle, including speed and distance traveled. Other vehicle status information including diagnostics can also be recorded to facilitate servicing and for keeping maintenance records.

Now referring to FIG. 3, a sample display in the display area 12 of device 10 is shown. The display may include a date field 62, a current time field 64, and a driver name field 66. The display may further include a graphical time bar 68 with quarter-hour increments provided along a horizontal axis. The time bar 68 may define an axis for, say, four possible states including an off duty state 70, a sleeper berth state 72, a driving state 74, and an on duty (but not driving) state 76. These states may be selected by the driver using the keypad 14. The off duty state 70 may be selected, for example, by simply turning off the device 10. The total amount of time spent in each state in a given time period may be indicated in corresponding fields 71, 73, 75 and 77. The changes in state may also be indicated graphically by a bar 79 which moves between the states 70, 72, 74, 78. Furthermore, the present state may be indicated by highlighting one of the states 70, 72, 74, 76 (in FIG. 3, the driving state 74 is highlighted) Associated with the driving state time bar 68 is a remarks field 78 indicating times at which the driver has entered remarks using, say, the writing pad 16.

It will be understood that a connection interface to the truck itself may prevent drivers from fraudulently recording driving time as off duty state, etc. This, of the truck is in operation, the interface can ensure that the device 10 automatically is in the driving state 74.

Still referring to FIG. 3, additional display fields may provide useful hours of service information back to the driver including driver time left 80, consecutive time off 82, and any of a number of other hours of service rules including, for example, a 10 hour rule 84, 15 hour rule 86, and 7 day rule 88. As the display 12 is a graphical user interface presented by a software program running on the data collection device 10, various other menu features can be provided including, for example, vehicle inspection 90, driving summary information 92, view options 94, and utility 96. These menu options may be selected by the driver using the keypad 14.

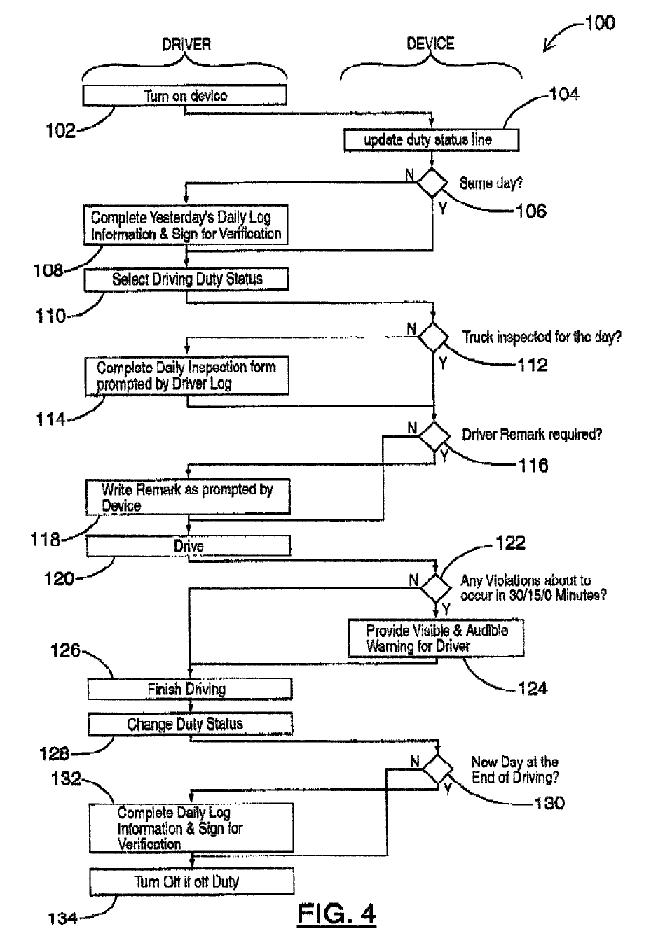

Now referring to FIG. 4, an example of how a drive interacts with a device 10 is shown by way of a flow-chart generally referred to by reference numeral 100. First, at block 102 a driver turns on the device 10. At block 104, the system updates the duty status line. At block 106, the system determines if it is the same day as when the machine was last turned off if yes, the system proceeds to block 110. If no, the system first proceeds to block 108 where yesterday's daily log information is completed and the driver is requested to sign at pad 16 (FIG. 2) for verification. The system then proceeds from block 108 to block 110. At block 110, the driver selects the driving duty status by means of keypad 14 (FIG. 2).

Next, at block 112, the system determines whether the truck has been inspected for the day. If yes, the system proceeds to block 120 and the driver is free to drive. If no, the system proceeds to block 118 where the driver is prompted to write a remark that the vehicle has been inspected. As the device 10 is portable, this allows the driver to use the device to make circle checks around the vehicle and can follow the driver when they are required to work in a different vehicle.

From block 118, the system proceeds to block 120 add the driver is free to drive. While the driver is driving, the system enters block 122 and the system periodically determines whether them are any hours of service violations about to occur in, say, 30 minutes, 15 minutes, and 0 minutes. If yes, the system proceeds to block 124 where a visible and/or audible warning is provided to the driver that he/she should rest. If no violations are about to occur, no warning is given and the system proceeds to block 126 where the driver finishes driving. At this point, the system proceeds to block 128 where the driver changes the duty status by means of keypad 14. The system then proceeds to block 130 where the system determines whether it is a new day at the end of driving. If yes, the system proceeds to block 132 where the system completes yesterday's daily log information and prompts the driver to sign for verification. The system then proceeds to block 134 where the driver turns off the device. If no, the system proceeds directly to block 134,

As described above, preferably, tho software program in the device 10 proactively manages the driver's time by continuous display of information including drive time remaining and recommending when to stop driving. The required log is automatically generated and the driver is prompted for the appropriate response if he/she does not appear to be following the hours of service regulations correctly. Also, in order to comply with different regulations in different jurisdictions, the device 10 may automatically update the hours of service rules when a driver crosses a border, for example, between Canada and the United States.

It will he appreciated that various other applications may be provided through the system described above. The data collection device 10 may be used, for example, for recording necessary data for fuel & miles tax. The device 10 may capture the truck's route via a GPS system while the driver enters fuel receipt information into the device. The driver may transmit the information to the ASP 40 where a fuel & miles tax web-application compiles all of the data on a carrier's fleet and generates the reports. Fuel receipt and trip information can also be entered directly into the web-application for clients who do not have their entire fleet connected via portable devices 10.

As another example, the system may incorporate a driver time sheet application. Truck drivers are typically reimbursed for their services by either hours worked or miles driven. Drivers can enter their hours worked, on a particular job or day, directly into the data collection device 10. A time-sheet web-application maintained by the ASP 40 can take this information and create time-sheet reports for the carrier's payroll department. Miles driven by the driver may be automatically collected using the fuel & miles tax web-application.

Yet another example of an application which may be incorporated into the system Is electronic mail. One of the challenges in trucking is a cost-effective method of relaying detailed information to drivers on the road. The portable devices 10 are driver based as opposed to vehicle based so they can function as a driver's own personal e-mail box. Either by sending a massage through the ASP 40 website or regular e-mail, the driver is able to receive these messages the next time he connects with the service. The advantage of this system is that anyone, including a driver's family, can send messages regardless of the driver's location or assigned vehicle. Multiple messages can be stored in the handheld for saving important information such as directions to a customer's site.

In summary, the disclosed system according to the present invention exists at the convergence of technologies, including the internet, wireless communications, and handheld devices. The transportation industry is slowly beginning to awaken to the potential of these technologies but has yet to adopt any one solution that has had a sizable impact on safety or profit. To the inventor's knowledge, the system described above is unique, and fills a need in the industry that no other system on the market can presently meet.

Associated with collecting the driving data are various other challenges facing motor carriers, namely, the auditing, reporting and storage of the information collected and the associated cost and difficulties of supporting the Information technology required for the task. Many companies have realized that it is more cost effective to outsource their information technology needs and concentrate on their core competencies. By hosting web-applications on a server provided by the ASP 40 to perform the necessary data processing tasks, and having clients 50 access the server via the internet, the clients are relieved from the task of generating internal reports, maintaining and storing data, and the need to purchasing expensive computer systems. The inventor believes that combining these various components together results in a more efficient and cost effective system for some motor carriers for managing their businesses.

All segments of the trucking industry can benefit from the system and method In accordance with the present invention. Medium to small for-hire and private truckload carriers can benefit from outsourcing data processing services, and from application of the service strategy according to the present invention. It is expected that the scalability of the system combined with low cost hand held devices will also appeal to large international carriers that need to collect data from a wide geographical area in a cost effective manner. Advantageously, the system according to the present invention is able to achieve significant economies of scale by utilizing the Internet as the primary communications infrastructure,

While a preferred embodiment of the present Invention has been shown and described by way of example, it will be appreciated that various changes and alterations may be made to the disclosed embodiment without departing from the spirit and scope of the present invention. It is therefore intended to cover in the following claims all of such changes and modifications that are within the scope of this invention.

1. A system for tracking driving data for a driver of a motor carrier comprising:
a) a portable computing device associated with said driver, said portable computing device being adapted to record driving data for said driver;
b) a wireless communications system coupled to said portable computing device for wirelessly connecting said device to a wide-area communications network; and
c) a software program accessible on said wide-area communications network for processing driving data received from said portable computing device through said wireless communications system.

2. The system claimed in claim 1, wherein, said driving data includes hours of service data for said driver.

3. The system claimed in claim 1, wherein, said driving date includes fuel and miles tax data for said driver.

4. The system claimed in claim 2 or 3, wherein, said portable computing device includes a memory for storing rules for hours of service in a given time period, and said device further includes a warning system responsive to the hours of service data for said driver for warning said driver when a rest period is required.

5. The system claimed in claim 2 or 3 or 4, wherein, said wireless communications system is adapted to communicate with a cellular telecommunications network.

6. The system claims in claim 5, wherein, said wide-area communications network comprises the Internet.

7. The system claimed in claim 6, wherein, said software program is accessible to a client through the internet.

8. A method for tracking driving data for a driver of a motor carrier, comprising the steps of:
a) providing a portable computing device associated with said driver;
b) recording driving data for said driver on said portable computing device;
c) communicating the driving data to a wide-area communications network using a wireless communications system coupled to said portable computing device: and
d) operating a software program accessible on said wide-area communications network for processing driving data received from said portable computing device through said wireless communications system.

9. The method claimed in claim 8, wherein, said method includes recording hours of service data for said driver.

10. The method claimed in claim 9, wherein, said method includes storing rules for hours of service in a given time period and warning said driver when a rest period is required based on the hours of service recorded for said driver.

11. The method claimed in claim 8, 9 or 10, wherein, said wireless communications system communicates with a cellular telecommunications network.

12. The method claimed in claim 11, wherein, said wide-area communications network comprises the internet.

13. The method claimed in claim 12, further including the step of accessing said software program through tho internet.

14. A portable device for tracking driver data for a driver of a motor carrier, comprising:
a) a memory for storing rules for hours of service and recording hours of service data for said driver;
b) a software program operating on said portable device for processing said hours of service data for said driver and comparing said hours of service data to said rules for hours of service to determine compliance with said rules; and
c) a warning system responsive to said hours of service data for warning said driver when compliance with said rules is about to be breached.
